(19) United States
(12) Patent Application Publication
(10) Pub. No.: US 2025/0103107 A1
(43) Pub. Date: Mar. 27, 2025

(54) CONTROL METHOD AND APPARATUS, AND ELECTRONIC DEVICE

(71) Applicant: Lenovo (Beijing) Limited, Beijing (CN)

(72) Inventors: Dongyang WANG, Beijing (CN); Dayuan HUANG, Beijing (CN); Bing XIE, Beijing (CN)

(21) Appl. No.: 18/896,399

(22) Filed: Sep. 25, 2024

(30) Foreign Application Priority Data
Sep. 27, 2023 (CN) 202311262250.8

(51) Int. Cl. G06F 1/16

(52) U.S. Cl. CPC G06F 1/1677; G06F 1/1652

(57) ABSTRACT

A control method includes obtaining a target angle between a first body and a second body of an electronic device and controlling a pulling speed of the first member at least according to the target angle. A flexible display includes a first member and a second member. The first member is arranged in the first body to be hidden by the first body. The second member is arranged at the second body to output content on the second body. The first member is able to be pulled, by a power structure of the electronic device, from the first body to the second body or from the second body back to the first body.

### CROSS-REFERENCE TO RELATED APPLICATION

The present disclosure claims priority to Chinese Patent Application No. 202311262250.8, filed on Sep. 27, 2023, the entire content of which is incorporated herein by reference.

### TECHNICAL FIELD

The present disclosure relates to the computer technology field and, more particularly, to a control method, a control apparatus, and an electronic device.

### BACKGROUND

Currently, a portion of a scroll display is located on a base section, while another portion is on a screen section. The scroll display is pulled between the base section and the screen section.

However, the pulling speed of the scroll display remains constant. Thus, the user experience of using the scroll display is poor.

### SUMMARY

The present disclosure provides a control method. The method includes obtaining a target angle between a first body and a second body of an electronic device and controlling a pulling speed of the first member at least according to the target angle. A flexible display includes a first member and a second member. The first member is arranged in the first body to be hidden by the first body. The second member is arranged at the second body to output content on the second body. The first member is able to be pulled, by a power structure of the electronic device, from the first body to the second body or from the second body back to the first body.

The present disclosure provides a control apparatus, including an angle acquisition unit and a speed control unit. The angle acquisition unit is configured to obtain a target angle between a first body and a second body of an electronic device. A flexible display includes a first member and a second member. The first member is arranged in the first body to be hidden by the first body. The second member is arranged at the second body to output content on the second body. The first member is able to be pulled, by a power structure of the electronic device, from the first body to the second body or from the second body back to the first body. A speed control unit is configured to control a pulling speed of the first member at least according to the target angle.

The present disclosure provides an electronic device, including a flexible display, a first body, a second body, and a control structure. The flexible display includes a first member and a second member. The first member is arranged in the first body to be hidden by the first body. The second member is arranged at the second body to output content on the second member. The first member is able to be pulled by the power structure from the first body to the second body or from the second body to the first body. The control structure is configured to obtain a target angle between the first body and the second body and control a pulling speed of the first member.

### BRIEF DESCRIPTION OF THE DRAWINGS

FIG. 1 illustrates a schematic flowchart of a control method according to some embodiments of the present disclosure.

FIG. 2 illustrates a schematic diagram of an electronic device according to some embodiments of the present disclosure.

FIG. 3 and FIG. 4 illustrate schematic diagrams showing states of pulling a flexible screen of an electronic device according to some embodiments of the present disclosure.

FIG. 5 illustrates a schematic diagram showing a correspondence between an angle and a speed according to some embodiments of the present disclosure.

FIG. 6 illustrates a schematic flowchart of another control method according to some embodiments of the present disclosure.

FIG. 7 and FIG. 8 illustrate schematic diagrams showing states of a first body and a second body of an electronic device according to some embodiments of the present disclosure.

FIG. 9 illustrates a schematic structural diagram of a control apparatus according to some embodiments of the present disclosure.

FIG. 10 illustrates a schematic structural diagram of an electronic device according to some embodiments of the present disclosure.

FIG. 11 illustrates a schematic diagram showing forces required to roll in/roll out a flexible screen in a Rollable PC according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Described embodiments are merely some embodiments of the present disclosure, not all embodiments. Based on embodiments of the present disclosure, all other embodiments obtained by those skilled in the art without creative efforts are within the scope of the present disclosure.

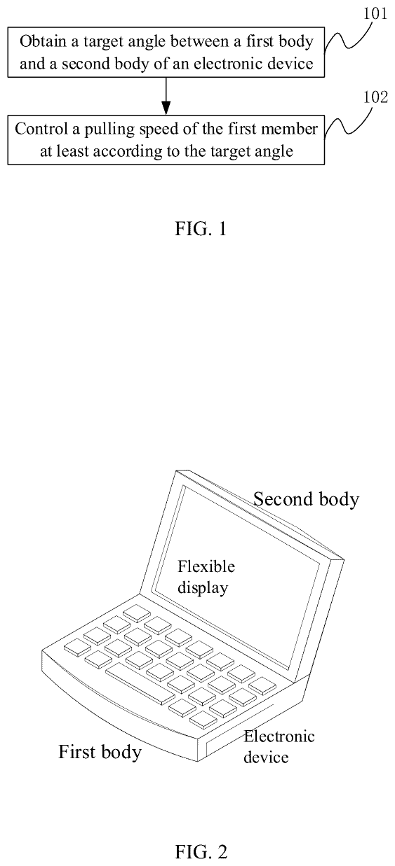

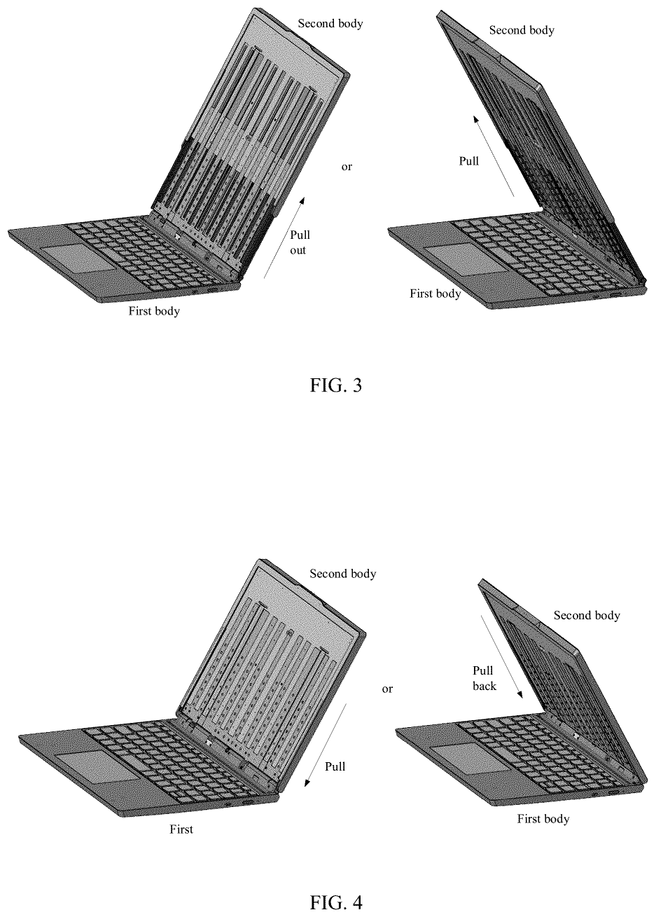

FIG. 1 illustrates a schematic flowchart of a control method according to some embodiments of the present disclosure. This method is applicable to an electronic device. The electronic device can include a first body and a second body. As shown in FIG. 2, the electronic device also includes a flexible display, such as a scroll display. The flexible display includes a first member and a second member. The first member is located in the first body. Thus, the first member is hidden by the first body. The second member is located in the second body to allow the second member to output content on the second body. The first member can be pulled by a power structure of the electronic device from the first body to the second body or pulled back from the second body to the first body. The first body can include an input apparatus such as a keyboard. The second member can include an output apparatus such as a display. The power structure can be a motor. When being powered on, the motor can pull the first member in response to a control command to cause the first member to be pulled from the first body to the second body or from the second body back to the first body. Thus, as shown in FIG. 3, an area for content output can be increased on the second body, while as shown in FIG. 4, the area for content output can be decreased on the second body.

In some embodiments, the method of embodiments of the present disclosure can include the following processes.

At 101, a target angle between the first body and the second body of the electronic device is obtained.

In some embodiments, an angle sensor can be arranged on the electronic device. The angle sensor can be configured to detect the target angle between the first body and the second body. Thus, the target angle between the first body and second body can be detected in real-time using the angle sensor.

At 102, a pulling speed of the first member is controlled at least according to the target angle.

When the target angle is in different angle ranges, the pulling speed of the first member can be different.

In some embodiments, in process 102, an angle range where the target angle is located can be determined first, a pulling speed corresponding to the angle range can be subsequently obtained according to the angle range, and the first member can be then pulled according to the pulling speed.

For example, a scroll display can be arranged on a laptop. In some embodiments, a correspondence table of an angle and a speed can be configured for the electronic device. The correspondence table of the angle and the speed can include a plurality of angle ranges. Each angle range can correspond to a speed value. Based on this, the angle range where the target angle is located can be first looked up in the correspondence table of the angle and the speed. Then, the first member of the scroll display can be pulled according to the speed corresponding to the angle range to move between the base section of the keyboard and the screen section.

In some embodiments, when the target angle is large or small, the pulling speed can be small. When the target angle is in a middle angle range, the pulling speed can be large.

For example, when the target angle is in a first angle range, the pulling speed can be a first speed. When the target angle is in a second angle range, the pulling speed can be a second speed. When the target angle is in a third angle range, the pulling speed can be a third speed.

When the minimum value of the first angle range is greater than the maximum value of the second angle range, and the minimum value of the second angle range is greater than the maximum value of the third angle range, the second speed can be greater than the first speed and third speed.

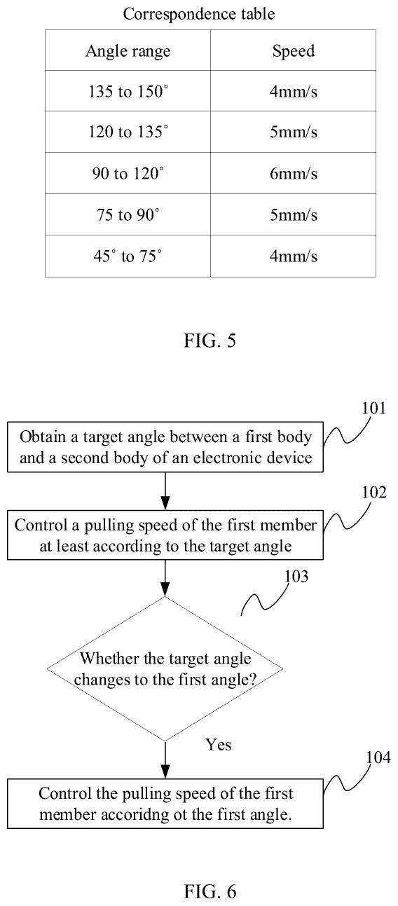

Taking the laptop as an example, in connection with the statuses shown in FIG. 3 and FIG. 4, and shown in the correspondence table in FIG. 5, a total angle range between surface AB, i.e., the base section of the keyboard, and surface CD, i.e., the screen section, ranges between 0 and 180°. Based on this, in some embodiments, when the angle between surface AB and surface CD is between 135° and 150°, the speed of pulling the scroll display is relatively small, e.g., 4 mm/s. When the angle between surface AB and surface CD is between 120° and 135°, the speed of pulling the scroll display is relatively large, e.g., 5 mm/s. When the angle between surface AB and surface CD is between 90° and 120°, the speed of pulling the scroll display is the largest, e.g., 6 mm/s. When the angle between surface AB and surface CD is between 75° and 90°, the speed of pulling the scroll display is relatively large, e.g., 5 mm/s. When the angle between surface AB and surface CD is between 45° and 75°, the speed of pulling the scroll display is relatively small, e.g., 4 mm/s. When the angle between surface AB and surface CD is larger than 150° or smaller than 75°, the scroll display cannot be pulled to move.

According to the above solution, embodiments of the present disclosure provide a control method. In the method, the pulling speed for the flexible display between the first body and the second body can be controlled according to the target angle between the first body and the second body. Thus, different pulling speeds can be realized by the different target angles to provide different application effects for the user and improve the user experience of the electronic device.

In some embodiments, the first member can correspond to a first moving status or a second moving status. The first moving status can represent that the first member can be pulled from the first body to the second body. The second moving status can represent that the first member can be pulled from the second body back to the first body.

When the target angle stays the same, the pulling speed of the first member in the first moving status can be different from the pulling speed of the first member in the second moving status.

For example, when the target angle between the first body and the second body stays the same, the pulling speed of the first member in the moving status in FIG. 3 is greater than the pulling speed of the first member in the moving status shown in FIG. 4. Taking a laptop as an example, when the keyboard base section and the screen section are fixed at 120°, the pulling speed for pulling the scroll display out from the keyboard base section can be faster than the pulling speed for pulling the scroll display back from the screen section.

In some embodiments, as shown in FIG. 6, after step 102 of controlling the pulling speed of the first member at least according to the target angle, the method further includes the following processes.

At 103, whether the target angle has changed is monitored, if the target angle changes to the first angle, proceed to process 104, and if no change, continue with process 103 until the target angle changes.

In some embodiments, whether the target angle changes can be monitored after controlling the pulling speed of the first member at least according to the target angle during pulling the first member. That is, when the first member is being pulled, whether the target angle changes can be continuously monitored. Once the target angle changes, the pulling speed can be adjusted in time. Thus, when the user thinks the pulling speed of the first member is slow, the target angle can be directly adjusted to an angle corresponding to a faster speed to increase the pulling speed of the first member and save time.

In some embodiments, the target angle between the first body and the second body can be detected in real time by the angle sensor of the electronic device. The first member can then be pulled according to the pulling speed corresponding to the target angle. The angle sensor can continuously monitor whether the target angle between the first body and the second body changes. If the target angle changes, the first angle between the first body and the second body can be detected by the angle sensor.

At 104, the pulling speed of the first member is controlled according to the first angle.

In some embodiments, according to the correspondence table in FIG. 5, the angle range of the first angle is looked up. Then, the first member can be pulled to move between the keyboard base section and the screen section at the corresponding first speed.

For example, when the user opens surface AB of the laptop and clicks an expand button of the scroll display, the laptop can respond to the expand command corresponding to the expand button to pull the scroll display from surface CD to surface AB through the motor according to the pulling speed of 5 mm/s corresponding to the target angle of 135° detected by the angle sensor. Thus, the display area can be increased. When the user wants to increase the expansion speed of the scroll display, the user can manually close surface AB and surface CD to 110°. Then, the scroll display can be pulled through the motor from surface CD to surface AB with a pulling speed of 6 mm/s corresponding to the target angle of 110° detected by the angle sensor. Thus, the expansion speed of the display area can be increased, and the user can experience the application effect of expanding the scroll display with an increased speed.

With the changes in the angle between the first body and the second body, the pulling speed of the first member can be changed to further improve the user experience of the electronic device.

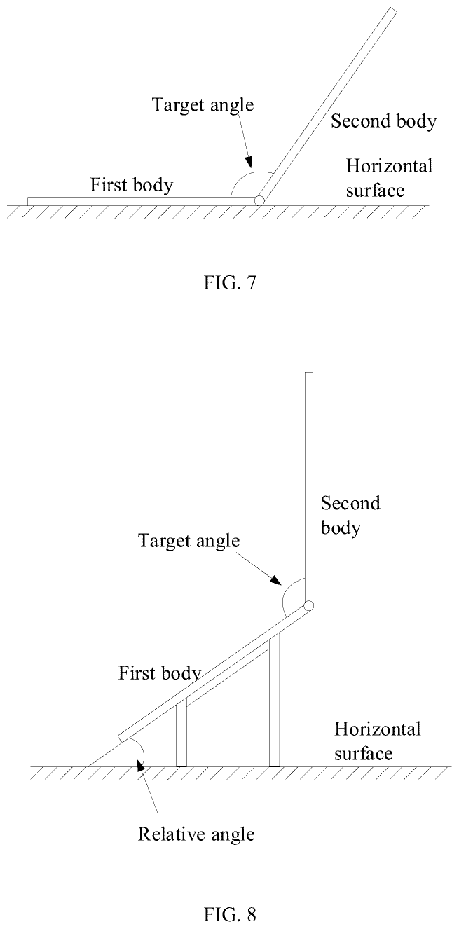

In some embodiments, as shown in FIG. 7, the first body is parallel to the horizontal surface. In process 102, the pulling speed is determined by directly using the target angle, and the first member is pulled according to the pulling speed. In some other embodiments, as shown in FIG. 8, the first member has a relative angle with the horizontal surface. In process 102, the pulling speed of the first member is controlled according to the target angle and the relative angle. The relative angle can be an angle between the second body and the horizontal surface.

When the first member is pulled to ascend or descend, and the first body has a certain angle with the gravity direction or the horizontal surface, the resistance received by the first body when being pulled can be different due to the leverage effect. In some embodiments, when the first body is in the gravity direction, i.e., perpendicular to the horizontal surface, the impact to the resistance can be the smallest.

Taking the laptop as an example, when surface CD has a certain relative angle with a table surface, the gravity of surface AB can cause friction when the first member is pulled to change. Then, in some embodiments, when the pulling speed of the first member is controlled, the pulling speed can be comprehensively controlled in connection with the target angle and the relative angle.

In some embodiments, the target speed can be determined according to the target angle, and the relative speed can be determined according to the relative angle. Then, a final speed can be obtained by performing a corresponding weighted sum or weighted average on the target speed and the relative speed. Then, the first member can be pulled according to the final speed.

In some other embodiments, the target angle can be adjusted according to the relative speed to obtain the updated angle. Then, the final speed can be determined according to the updated angle. Then, the first member can be pulled according to the final speed.

In some embodiments, in process 102, controlling the pulling speed of the first member at least according to the target angle can include controlling the power structure to rotate according to the target angle to cause the power structure to pull the first member at the target speed. The rotation speed of the power structure can be consistent with the target speed, and the rotation speed of the power structure can match the target angle.

The power structure can be a motor or an engine. The power structure can realize the required rotation speed through a structure such as a rotation shaft. Based on this, the power structure can be controlled to rotate according to the target speed corresponding to the target angle to cause the first member to be pulled between the first member and the second member at the target speed.

In some embodiments, a target pulling force corresponding to the target angle can be obtained according to the target angle. Then, the target speed can be obtained according to the target pulling force and the target angle. The target speed can be used to control the power structure to rotate to cause the power structure to pull the first member at the target speed.

For example, the motor of the laptop can determine the target pulling force corresponding to the motor according to the target angle. Then, the target speed can be determined based on the target pulling force and the target angle. Thus, the motor can be controlled to rotate according to the target speed at the laptop to pull the first member with the target pulling force. Then, the first member can be pulled from the first body to the second body or from the second body to the first body according to the target speed.

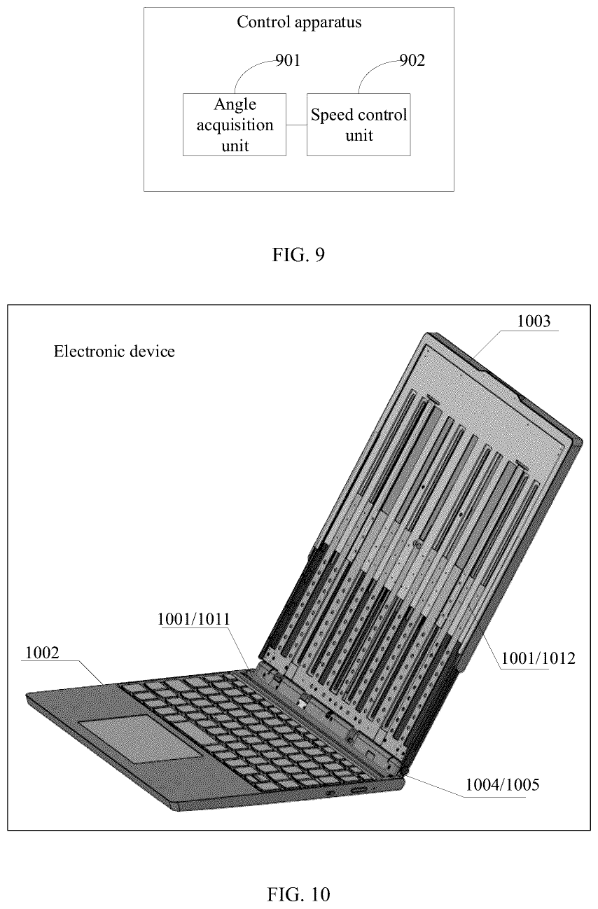

FIG. 9 illustrates a schematic structural diagram of a control apparatus according to some embodiments of the present disclosure. The apparatus is configured in the electronic device in FIG. 2.

The apparatus of embodiments of the present disclosure includes an angle acquisition unit 901 and a speed control unit 902.

The angle acquisition unit 901 can be configured to obtain the target angle between the first body and the second body of the electronic device. The flexible display can include the first member and the second member. The first member can be arranged in the first body. Thus, the first member can be hidden by the first body. The second member can be at the second body. Thus, the second member can output content on the second body. The first member can be pulled from the first body to the second body or from the second body back to the first body by the power structure of the electronic device.

The speed control unit 902 can be configured to control the speed for pulling the first member according to the target angle.

Based on the above, in the control apparatus of embodiments of the present disclosure, the pulling speed of the flexible display between the first body and the second body can be controlled according to the target angle between the first body and the second body. Thus, different pulling speeds can be realized with different angles to provide different application effects for the user to further improve the user experience for the electronic device.

In some embodiments, the speed control unit 902 can be configured to determine the angle range where the target angle is located, obtain the target speed corresponding to the angle range according to the angle range, and pull the first member according to the target speed.

When the target angle is in the first angle range, the target speed can be the first speed. When the target angle is in the second angle range, the target speed can be the second speed. When the target angle is in the third angle range, the target speed can be the third speed. The minimum value of the first angle range can be greater than the maximum value of the second angle range. The minimum value of the second angle range can be greater than the maximum value of the third angle range. The second speed can be greater than the first speed, and the second speed can be greater than the third speed.

In some embodiments, the first member can include the first moving status or the second moving status. The first moving status can represent that the first member is pulled from the first body to the second body. The second moving status can represent that the first member is pulled from the second body back to the first body. When the target angle stays the same, the pulling speed of the first member in the first moving status can be different from the pulling speed of the first member in the second moving status.

In some embodiments, the angle acquisition unit 901 can be further configured to monitor whether the target angle changes. The speed control unit 902 can be further configured to control the pulling speed of the first member according to the first angle if the target angle changes to the first angle.

In some embodiments, the speed control unit 902 can be configured to control the pulling speed of the first member according to the target angle and the relative angle. The relative angle can be the angle between the second body and the horizontal surface.

For example, the speed control unit 902 can be configured to control the power structure to rotate according to the target angle to cause the power structure to pull the first member at the target speed. The rotation speed of the power structure can be consistent with the target speed and match the target angle.

In some embodiments, the speed control unit 902 can be configured to obtain the target pulling force corresponding to the target angle according to the target angle and obtain the target speed according to the target pulling force and the target angle. The target speed can be used to control the rotation of the power structure to cause the power structure to pull the first member at the target speed.

For the implementation of the units, reference can be made to the corresponding content above, which is not repeated here.

FIG. 10 illustrates a schematic structural diagram of an electronic device according to some embodiments of the present disclosure. The electronic device includes a flexible display 1001, a first body 1002, a second body 1003, a power structure 1004, and a control structure 1005.

The flexible display 1001 includes a first member 1011 and a second member 1012. The first member 1011 is arranged in the first body 1002. Thus, the first member 1011 is hidden by the first body 1002. The second member 1012 is arranged at the second body 1003. Thus, the second member 1012 can output content on the second body 1003. The first member 1011 can be pulled from the first body 1002 to the second body 1003 or from the second body 1003 back to the first body 1002 by the power structure 1004.

The control structure 1005 can be configured to obtain the target angle between the first body 1002 and the second body 1003 and control the pulling speed of the first member 1011 at least according to the target angle.

Based on the above, in the electronic device of embodiments of the present disclosure, the pulling speed of the flexible display between the first body and the second body can be controlled according to the target angle between the first body and the second body. Thus, different pulling speeds can be realized at different angles to provide different application effects for the user to improve the user experience for the electronic device.

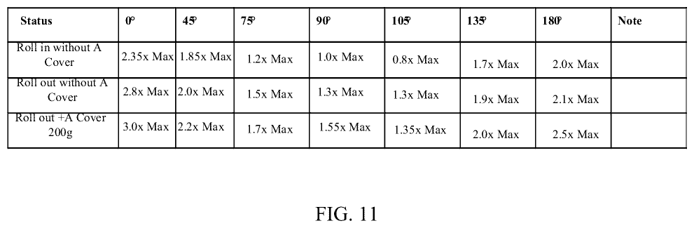

Taking a Rollable PC as an example, with different sizes of the angle between the display of the PC and the base, different forces are required for roll in/roll out. As shown in FIG. 11, when the angle is at 75°, a highest pulling force of 1.7 kg is required during roll out. When the angle is at 90°, a pulling force of 1.5 kg is required during roll out. When the angle is at 105°, a pulling force of 1.3 kg is required during roll out. The main reason can include that a larger pulling force is required during rolling when a bending radius is smaller due to the manufacturing process of the flexible display and the friction of the structure members.

Currently, the maximum load capacity of the motors for selection can be around 1.7 kg. When two motors push simultaneously, the push force can be around 2.5 kg. When the product is manufactured, a sufficient thrust margin may need to be reserved. The load capacity of the motors that are operated together can be inversely proportional to the rotation speed of the motor. When the rotation speed of the motor is higher, the load capacity can be smaller. To cause the display to scroll normally, the angle where the display can scroll can be defined as greater than 90°.

The following problems include that only when the angle between the display and the base is greater than 90°, the display can be scrolled which affects the user experience, and to reserve sufficient thrust margin, the display can be scrolled at a fixed speed which makes the speed difficult to be optimized.

For the above problems, an angle sensor can be added to the present disclosure and can be configured to calculate the angle between the display and the base and adjust the speed of the motor in real time according to the angle and the pulling force required by the angle to increase or decrease the display scroll speed. For example, when the angle between the display and the base is between 135° and 150°, the scroll speed can be 4 mm/s. When the angle between the display and the base is between 120° and 135°, the scroll speed can be 5 mm/s. When the angle between the display and the base is between 90° and 120°, the scroll speed can be 6 mm/s. When the angle between the display and the base is between 75° and 90°, the scroll speed can be 5 mm/s. When the angle between the display and the base is between 45° and 75°, the scroll speed can be 4 mm/s.

When the angle is greater than 150° or smaller than 45°, the display cannot be scrolled.

Thus, after the present disclosure is applied, the range that the screen can scroll can be increased, and the smallest can be 45° which improves the user experience of the user.

Embodiments of the present disclosure are described progressively. Each embodiment can focus on the difference from other embodiments, and similar parts across embodiments can be referred to each other. For apparatus embodiments, since the apparatus corresponds to the method of embodiments of the present disclosure, the description can be simple. For the relevant parts, reference can be made to the description of the method.

Those skilled in the art can further realize that the units and algorithm steps described in embodiments of the present disclosure can be implemented by electronic hardware, computer software, or a combination thereof. To describe the interchangeability of hardware and software, the embodiments are described generally according to the functions in the above description. Whether the functions are executed in hardware or software depends on the specific application and design constraints of the technical solution. Those skilled in the art can implement the described functions using different methods for each specific application, but such implementation should not be considered outside the scope of the present disclosure.

The steps of the methods or algorithms described in embodiments of the present disclosure can be directly implemented by hardware, a software module executed by a processor, or a combination thereof. The software module can be arranged in random access memory (RAM), memory, read-only memory (ROM), electrically programmable ROM, electrically erasable programmable ROM, registers, hard drives, removable disks, CD-ROMs, or any other form of storage medium known in the technical field.

The above description of embodiments of the present disclosure enables those skilled in the art to implement or use the present disclosure. Various modifications to embodiments of the present disclosure can be obvious to those skilled in the art. The general principle defined in the present disclosure can be implemented in other embodiments without departing from the spirit or scope of the present disclosure. Thus, the present disclosure is not limited to embodiments of the present disclosure but should conform to the widest scope of the principle and novel features of the present disclosure.

What is claimed is:

1. A control method comprising:
obtaining a target angle between a first body and a second body of an electronic device, wherein:
a flexible display includes a first member and a second member;
the first member is arranged in the first body to be hidden by the first body;
the second member is arranged at the second body to output content on the second body; and
the first member is able to be pulled, by a power structure of the electronic device, from the first body to the second body or from the second body back to the first body; and
controlling a pulling speed of the first member at least according to the target angle.

2. The method according to claim 1, wherein controlling the pulling speed of the first member at least according to the target angle includes:
determining an angular range where the target angle is located;
obtaining a target speed corresponding to the angular range according to the angle range; and
pulling the first member according to the target speed.

3. The method according to claim 2, wherein:
in response to the target angle being in a first angular range, the target speed is a first speed;
in response to the target angle being in a second angular range, the target speed is a second speed;
in response to the target angle being in a third angular range, the target speed is a third speed; and
a minimum value of the first angle range is greater than a maximum value of the second angle range, a minimum value of the second angle range is greater than a maximum value of the third angle range, the second speed is greater than the first speed, and the second speed is greater than the third speed.

4. The method according to claim 2, wherein:
the first member includes a first moving status or a second moving status,
the first moving status represents that the first member is pulled from the first body to the second body, and the second moving status represents that the first member is pulled back from the second body to the first body; and
when the target angle stays the same, the pulling speed of the first member in the first moving status is different from the pulling speed of the first member in the second moving status.

5. The method according to claim 2, further comprising, after controlling the pulling speed of the first member at least according to the target angle:
monitoring whether the target angle changes; and
in response to the target angle changing to the first angle, controlling the pulling speed of the first member according to the first angle.

6. The method according to claim 2, wherein controlling the pulling speed of the first member at least according to the target angle includes:
controlling the pulling speed of the first member according to the target angle and a relative angle, wherein the relative angle is an angle of the second body relative to a horizontal surface.

7. The method according to claim 2, wherein controlling the pulling speed of the first member at least according to the target angle includes:
controlling the power structure to rotate according to the target angle to cause the power structure to pull the first member at the target speed, a rotation speed of the power structure being consistent with the target speed, and the rotation speed of the power structure matching the target angle.

8. The method according to claim 7, wherein controlling the power structure to pull the first member at the target speed according to the target angle includes:
obtaining a target pulling force corresponding to the target angle according to the target angle; and
obtaining the target speed according to the target pulling force and the target angle, wherein the target speed is used to control the power structure to rotate to cause the power structure to pull the first member at the target speed.

9. A control apparatus comprising:
an angle acquisition unit configured to obtain a target angle between a first body and a second body of an electronic device, wherein:
a flexible display includes a first member and a second member;
the first member is arranged in the first body to be hidden by the first body;
the second member is arranged at the second body to output content on the second body; and
the first member is able to be pulled, by a power structure of the electronic device, from the first body to the second body or from the second body back to the first body; and
a speed control unit configured to control a pulling speed of the first member at least according to the target angle.

10. The control apparatus according to claim 9, wherein the speed control unit is further configured to:
determine an angular range where the target angle is located;
obtain a target speed corresponding to the angular range according to the angle range; and
pull the first member according to the target speed.

11. The control apparatus according to claim 10, wherein:
in response to the target angle being in a first angular range, the target speed is a first speed;
in response to the target angle being in a second angular range, the target speed is a second speed;
in response to the target angle being in a third angular range, the target speed is a third speed; and
a minimum value of the first angle range is greater than a maximum value of the second angle range, a minimum value of the second angle range is greater than a maximum value of the third angle range, the second speed is greater than the first speed, and the second speed is greater than the third speed.

12. The control apparatus according to claim 10, wherein:
the first member includes a first moving status or a second moving status,
the first moving status represents that the first member is pulled from the first body to the second body, and the second moving status represents that the first member is pulled back from the second body to the first body; and
when the target angle stays the same, the pulling speed of the first member in the first moving status is different from the pulling speed of the first member in the second moving status.

13. An electronic device comprising:
a flexible display including a first member and a second member;
a first body, the first member being arranged in the first body to be hidden by the first body;
a second body, the second member being arranged at the second body to output content on the second member;
a power structure, the first member being able to be pulled by the power structure from the first body to the second body or from the second body to the first body; and
a control structure configured to obtain a target angle between the first body and the second body and control a pulling speed of the first member.

14. The device according to claim 13, wherein the control structure is further configured to:
determine an angular range where the target angle is located;
obtain a target speed corresponding to the angular range according to the angle range; and
pull the first member according to the target speed.

15. The device according to claim 14, wherein:
in response to the target angle being in a first angular range, the target speed is a first speed;
in response to the target angle being in a second angular range, the target speed is a second speed;
in response to the target angle being in a third angular range, the target speed is a third speed; and
a minimum value of the first angle range is greater than a maximum value of the second angle range, a minimum value of the second angle range is greater than a maximum value of the third angle range, the second speed is greater than the first speed, and the second speed is greater than the third speed.

16. The device according to claim 14, wherein:
the first member includes a first moving status or a second moving status,
the first moving status represents that the first member is pulled from the first body to the second body, and the second moving status represents that the first member is pulled back from the second body to the first body; and
when the target angle stays the same, the pulling speed of the first member in the first moving status is different from the pulling speed of the first member in the second moving status.

17. The device according to claim 14, the control structure is further configured to:
monitor whether the target angle changes; and
in response to the target angle changing to the first angle, control the pulling speed of the first member according to the first angle.

18. The device according to claim 14, wherein the control structure is further configured to:
control the pulling speed of the first member according to the target angle and a relative angle, wherein the relative angle is an angle of the second body relative to a horizontal surface.

19. The device according to claim 14, wherein the control structure is further configured to:
control the power structure to rotate according to the target angle to cause the power structure to pull the first member at the target speed, a rotation speed of the power structure being consistent with the target speed, and the rotation speed of the power structure matching the target angle.

20. The device according to claim 19, wherein the control structure is further configured to:
obtain a target pulling force corresponding to the target angle according to the target angle; and
obtain the target speed according to the target pulling force and the target angle, wherein the target speed is used to control the power structure to rotate to cause the power structure to pull the first member at the target speed.
